(19) United States
(12) Patent Application Publication
(10) Pub. No.: US 2017/0235363 A1
(43) Pub. Date: Aug. 17, 2017

(54) Method and System for Calibrating an Eye Tracking System

(71) Applicant: Bayerische Motoren Werke Aktiengesellschaft, Muenchen (DE)

(72) Inventors: Marc BREISINGER, Muenchen (DE); Michael EHRMANN, Cupertino, CA (US); Felix SCHWARZ, Muenchen (DE); Philipp SUESSENGUTH, Muenchen (DE); Julian EICHHORN, Muenchen (DE)

(21) Appl. No.: 15/584,104

(22) Filed: May 2, 2017

Related U.S. Application Data
(63) Continuation of application No. PCT/US2014/063671, filed on Nov. 3, 2014.

(51) Int. Cl. G06F 3/01; G06F 3/0482

(52) U.S. Cl. CPC G06F 3/013; G06F 3/0482

(57) ABSTRACT

A method for selecting a first area from a viewing zone which has a plurality of selectable areas is described. The method has measures a point of gaze of a user on the viewing zone, thereby providing a measured point of gaze. Furthermore, the method determines an estimated point of gaze based on the measured point of gaze and displays information regarding the estimated point of gaze on the viewing zone. The method also captures displacement information which is directed at dislocating the displayed information on the viewing zone. An actual point of gaze is determined based on the measured point of gaze and based on the captured displacement information. Furthermore, a first area which corresponds to the actual point of gaze is selected from the plurality of selectable areas.

### CROSS REFERENCE TO RELATED APPLICATIONS

This application is a continuation of PCT International Application No. PCT/US2014/063671, filed Nov. 3, 2014, the entire disclosure of which is herein expressly incorporated by reference.

### FIELD OF THE INVENTION

The present document relates to systems which are controlled using eye tracking mechanisms. In particular, the present document relates to the calibration of an eye tracking based user interface system.

### BACKGROUND OF THE INVENTION

Eye tracking may be used to provide a fast and intuitive user interface, e.g. within vehicles such as automobiles. Using a camera, the point of gaze of a user may be measured. The point of gaze may correspond to a particular area of a plurality of selectable areas. Subject to detecting that the user looks at the particular area, an action or function which is associated with the particular area may be executed. By doing this, different actions or functions which are associated with the different selectable areas may be initiated by a user simply by looking at the different selectable areas.

In order to provide a reliable user interface, eye tracking based user interface systems typically need to be calibrated. Otherwise, the measured point of gaze may differ from the actual point of gaze of the user. In other words, a lack of calibration may lead to an offset between the measured point of gaze and the actual point of gaze. This offset may depend on the direction of sight and notably on the viewing angle of the user onto a selectable area.

The offset between a measured point of gaze and an actual point of gaze may lead to a situation where the detected area differs from the area which a user wants to select. As a result of this, the reliability and the user acceptance of an eye tracking based user interface system may be relatively low.

Furthermore, the performance of eye tracking may be dependent on the user which uses the eye tracking based user interface, on current light conditions, etc. As a result of this, calibration may need to be repeated frequently, which is typically not acceptable for a user.

The present document describes methods and systems which provide a reliable and flexible eye tracking based user interface.

### SUMMARY OF THE INVENTION

According to an aspect, a method for selecting a first area from a viewing zone which comprises a plurality of selectable areas is described. The method comprises measuring a point of gaze of a user on the viewing zone, thereby providing a measured point of gaze. Furthermore, the method comprises determining an estimated point of gaze based on the measured point of gaze, and displaying information regarding the estimated point of gaze on the viewing zone. In addition, the method comprises capturing displacement information which is directed at dislocating the displayed information on the viewing zone. Furthermore, the method comprises determining an actual point of gaze based on the measured point of gaze and based on the captured displacement information. In addition, the method comprises selecting a first area from the plurality of selectable areas, which corresponds to the actual point of gaze.

According to a further aspect, a control unit for an eye tracking based user interface system is described. The control unit is configured to determine a measured point of gaze of a user on a viewing zone of the eye tracking based user interface system, wherein the viewing zone comprises a plurality of selectable areas. Furthermore, the control unit is configured to determine an estimated point of gaze based on the measured point of gaze and to cause the output of information regarding the estimated point of gaze on the viewing zone. In addition, the control unit is configured to determine displacement information which is directed at dislocating the displayed information on the viewing zone and to determine an actual point of gaze based on the measured point of gaze and based on the captured displacement information. Furthermore, the control unit is configured to select a first area from the plurality of selectable areas, which corresponds to the actual point of gaze.

According to a further aspect, an eye tracking based user interface system is described which comprises an image sensor configured to capture image data regarding a point of gaze of a user of the eye tracking based user interface system. Furthermore, the eye tracking based user interface system comprises a viewing zone configured to provide a plurality of selectable areas with selectable areas that are visibly distinct. The viewing zone is configured to provide visible information regarding an estimated point of gaze of the user on the viewing zone. In addition, the eye tracking based user interface system comprises a tactile input device configured to capture displacement information which is input by the user for dislocating the information regarding the estimated point of gaze. Furthermore, the eye tracking based user interface system comprises a control unit as described in the present document.

According to a further aspect, a vehicle (e.g. an automobile, a motorbike or a truck) is described which comprises a control unit and/or an eye tracking based user interface as described in the present document.

According to a further aspect, a software program is described. The software program may be adapted for execution on a processor and for performing the method steps outlined in the present document when carried out on the processor.

According to another aspect, a storage medium is described. The storage medium may comprise a software program adapted for execution on a processor and for performing the method steps outlined in the present document when carried out on the processor.

According to a further aspect, a computer program product is described. The computer program may comprise executable instructions for performing the method steps outlined in the present document when executed on a computer.

It should be noted that the methods and systems including its preferred embodiments as outlined in the present document may be used stand-alone or in combination with the other methods and systems disclosed in this document. In addition, the features outlined in the context of a system are also applicable to a corresponding method (and vice versa). Furthermore, all aspects of the methods and systems outlined in the present document may be arbitrarily combined. In particular, the features of the claims may be combined with one another in an arbitrary manner.

### BRIEF DESCRIPTION OF THE DRAWINGS

The invention is explained below in an exemplary manner with reference to the accompanying drawings.

FIG. 1 is a block diagram of an exemplary eye tracking based user interface system; and

FIG. 2 is a flow chart of an exemplary method for determining an input on an eye tracking based user interface system.

### DETAILED DESCRIPTION OF THE DRAWINGS

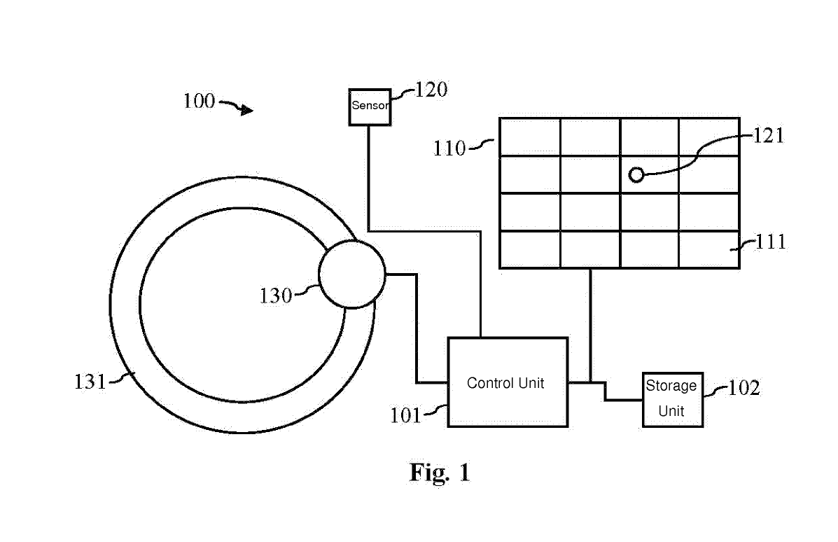

FIG. 1 shows an exemplary system 100 for providing an eye tracking based user interface. The eye tracking based user interface system 100 comprises a viewing zone 110 with a plurality of selectable areas 111. The selectable areas 111 are typically visibly distinct for a user of the system 100. The user may look at any of the plurality of selectable areas 111 for initiating different actions or functions which are associated with the different selectable areas of the viewing zone 110.

A camera 120 is used to capture image data of one or two eyes of the user. The image data may be forwarded to a control unit 101 which is configured to analyze the image data and which is configured to measure a point of gaze of the user based on the image data. The measured point of gaze may lie within the viewing zone 110 (as illustrated in FIG. 1). Information 121 regarding the measured point of gaze may be displayed on the viewing zone 110. By way of example, an icon 121 which represents the measured point of gaze may be displayed on the viewing zone 110. Alternatively or in addition, the selectable area 111 which corresponds to the measured point of gaze (e.g. the selectable area 111 that comprises the measured point of gaze) may be highlighted.

An estimated point of gaze may be determined based on the measured point of gaze. As will be outlined below, offset information regarding a measured point of gaze may be determined by the control unit 101. The estimated point of gaze may be determined based on the measured point of gaze and based on the offset information. Alternatively or in addition to displaying information 121 regarding the measured point of gaze, information 121 regarding the estimated point of gaze may be displayed within the viewing zone 110. In the following, the displayed information 121 may relate to information regarding the measured point of gaze and/or information regarding the estimated point of gaze.

The control unit 101 may be configured to determine the measured and/or the estimated point of gaze based on the point of gaze of a user at a particular point in time, which may be referred to as the visual input time instant. The displayed information 121 may be determined using the measured and/or the estimated point of gaze at the visual input time instant. Eye movements of a user's eye, which are subsequent to the visual input time instant may be ignored (at least for a certain time period). The visual input time instant may be triggered by a particular user input (e.g. by a wink of a user's eye). As such, the visual input time instant may be regarded as a “freeze” point for determining a measured and/or the estimated point of gaze.

The eye tracking based user interface system 100 may comprise a tactile input device 130 (e.g. a touch pad) which is configured to capture displacement information that is input by the user on the tactile input device 130. The displacement information may be directed at displacing or offsetting the displayed information 121. In particular, the tactile input device 130 may allow the user to displace a displayed icon of the measure point of gaze to a different position on the viewing zone 110, such that the position of the icon corresponds to the actual point of gaze of the user.

In the illustrated example, the tactile input device 130 is positioned at a steering wheel 131 of a vehicle. As such, the driver of a vehicle may displace a measured and/or estimated point of gaze (i.e. the displayed information 121 which represents the measured and/or estimated point of gaze) in a comfortable manner while keeping his/her hand on the steering wheel 131 of the vehicle.

The displacement information may be captured at a displacement input time instant which is subsequent to the visual input time instant. The displacement input time instant may be triggered by a particular user input (e.g. by a press of the user onto the tactile input device 130). By way of example, a user may dislocate the displayed information 121 until the visual input time instant (e.g. when the user presses the tactile input device 130 with a finger), and the displacement information may be captured at the visual input time instant.

The displacement information which is captured via the tactile input device 130 may be used to determine an offset between the measured point of gaze and the actual point of gaze of a user. The determined offset may be stored within a storage unit 102 and may be used for calibration of the eye tracking based user interface system 100.

By way of example, offset information may be determined and stored for each selectable area 111 of the viewing zone 110. Table 1 shows an exemplary array of offsets (also referred to as an offset file) for the viewing zone 110. The array comprises offset data for each selectable area 111 of the viewing zone 110. Upon start-up of the eye tracking based user interface system 100, the offset data may be initialized to zero offset as shown in Table 1.

TABLE 1

| | | | |
|---|---|---|---|
| X = 0; Y = 0 | X = 0; Y = 0 | X = 0; Y = 0 | X = 0; Y = 0 |
| X = 0; Y = 0 | X = 0; Y = 0 | X = 0; Y = 0 | X = 0; Y = 0 |
| X = 0; Y = 0 | X = 0; Y = 0 | X = 0; Y = 0 | X = 0; Y = 0 |
| X = 0; Y = 0 | X = 0; Y = 0 | X = 0; Y = 0 | X = 0; Y = 0 |

During the usage of the eye tracking based user interface system 100, offset data may be determined using the displacement information captured by the tactile input device 130. This offset data may be used to update the offset data which is stored within the array of offsets. By way of example, the determined offset data for a particular selectable area 111 may be used to overwrite the offset data which is stored for the particular selectable area 111. Alternatively, a weighted average between the determined offset data and the stored offset data may be calculated and stored as the updated offset data.

Furthermore, the determined offset data for a particular selectable area 111 may be used to update the offset data of areas 111 in the vicinity of the particular selectable area 111. By way of example, the determined offset data for the particular selectable area 111 may also be used as offset data for the adjacent areas 111. Alternatively or in addition, the offset data of different areas 111 may be interpolated.

As such, the array of offset data or an offset file may be continuously updated, thereby allowing the eye tracking based user interface system 100 to be automatically adapted to different lighting conditions and/or possible different users. Alternatively or in addition, different arrays of offset data may be stored as profiles for different users, in order to efficiently adapt the eye tracking based user interface system 100 to different users.

The control unit 101 may be configured to determine an estimate of the actual point of gaze under consideration of the array of offsets. In particular, the control unit 101 may be configured to determine the measured point of gaze based on the image data provided by the camera 120. Furthermore, the control unit 101 may be configured to offset the measured point of gaze using the offset data comprised within the array of offsets. In particular, the control unit 101 may determine the area 111 which corresponds to the measured point of gaze. Furthermore, the offset data which corresponds to this area 111 may be taken from the array of offsets. The estimate of the actual point of gaze (which is also referred to as the estimated point of gaze) may correspond to the measured point of gaze which is offset using the offset data taken from the array of offsets.

The control unit 101 may then determine the area 111 which corresponds to the estimated point of gaze. Furthermore, information 121 regarding the estimated point of gaze may be displayed within the viewing zone 110 (e.g. by displaying an icon or by highlighting the area 111 which corresponds to the estimated point of gaze).

Furthermore, the displayed information 121 may be used for further calibration of the eye tracking based user interface (as outlined above). For this purpose, displacement information regarding the dislocation of the displayed information 121 may be captured. By way of example, the control unit 101 may be configured to determine whether displacement information is input via the input device 130 within a pre-determined time interval subsequent to the visual input time instant. If such displacement information is input, then this displacement information is captured and used to determine an improved estimate of the actual point of gaze (as outlined above). Otherwise, it is assumed that the displayed information 121 represents a correct estimate of the actual point of gaze. Hence, either subsequent to the displacement input time instant or subsequent to the pre-determined time interval, an “actual point of gaze” may be determined. The control unit 101 may determine one of the plurality of selectable areas 111, based on this “actual point of gaze”.

The control unit 101 may be further configured to initiate an action or function which corresponds to the determined area 111. For this purpose, the control unit 101 may be configured to access the storage unit 102 to consult a pre-determined mapping between selectable area 111 and an action or function which is associated with the selectable area 111.

As such, the tactile input device 130 provides a user of the eye tracking based user interface system 100 with efficient and intuitive means for modifying the focus of the eye tracking based user interface, i.e. for implicitly calibrating and adapting the eye tracking based user interface. The tactile input device 130 allows the user to initiate the same actions as the eye tracking based user interface, e.g. if the eye tracking based user interface does not function correctly. Notably in cases of an erroneous calibration of the eye tracking based user interface, the user will likely correct the estimated point of gaze which is determined by the eye tracking based user interface by providing displacement information via the tactile input device 130. Notably in cases where the displacement which is triggered by the tactile input device 130 is minor (e.g. for moving an estimated point of gaze to an adjacent area 111), the captured displacement information may be interpreted by the control unit 101 as a correction of the estimated point of gaze, i.e. as an offset of the estimated point of gaze, which is to be applied in order to align the measured point of gaze with the actual point of gaze.

In cases where multiple corrections are captured via the tactile input device 130, i.e. in cases where multiple offsets are determined, the multiple offsets may be interpolated, in order to provide reliable offset data for the complete viewing zone 110.

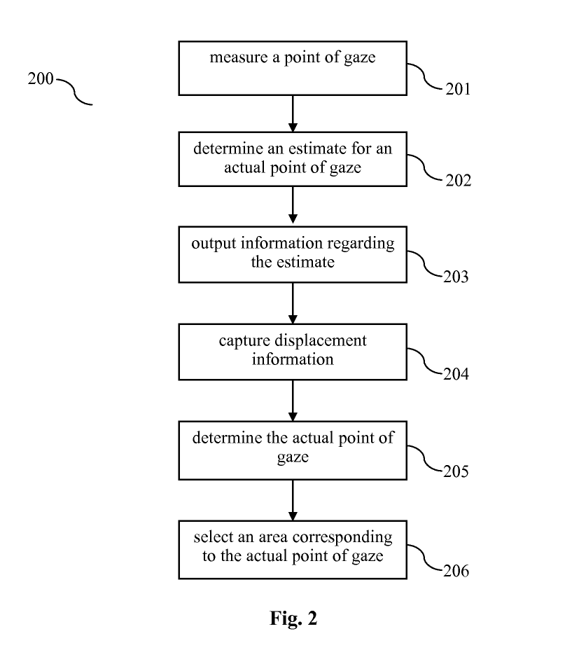

FIG. 2 shows a flow chart of an exemplary method 200 for selecting a first area 111 from a viewing zone 110 which comprises a plurality of selectable areas 111. The selectable areas 111 from the plurality of selectable areas 111 are typically visibly distinct for a user. Furthermore, the areas 111 from the plurality of selectable areas 111 are typically adjacent with respect to one another. By way of example, a selectable area 111 may correspond to a physical or virtual button within the viewing zone 110. The viewing zone 110 may be positioned on a dashboard of a vehicle.

The method 200 comprises measuring 201 a point of gaze of a user on the viewing zone 110, thereby providing a measured point of gaze. The point of gaze of a user may be determined using image data which is captured by an image sensor 120 (e.g. a camera). The camera may be directed at the user. As such, the image data may comprise information regarding the pupil of at least one eye of the user. The measured point of gaze may be determined using image processing algorithms which are applied to the image data that is captured by the image sensor 120.

Furthermore, the method 200 comprises determining 202 an estimated point of gaze based on the measured point of gaze. In an example, the estimated point of gaze corresponds to or is equal to the measured point of gaze. Alternatively or in addition, the estimated point of gaze may be determined using offset data which may be stored within an offset file (e.g. within an array of offsets). In particular, a first offset for the measured point of gaze may be determined from an offset file. By way of example, the selectable area 111 which corresponds to the measured point of gaze may be determined. The first offset may correspond to the offset which is stored for this selectable area 111 within the offset file. The estimated point of gaze may be determined by offsetting the measured point of gaze using the first offset.

The method 200 further comprises displaying 203 information 121 regarding the estimated point of gaze on the viewing zone 110. By way of example, a visible icon or point may be displayed at the position of the estimated point of gaze on the viewing zone 110. Alternatively or in addition, a selectable area 111 from the plurality of selectable areas 111 that the estimated point of gaze corresponds to may be highlighted. By way of example, the viewing zone 110 may comprise a display and the plurality of areas 111 may be displayed on the display (e.g. as tiles). A selectable area 111 may be highlighted by changing a color or a brightness of the displayed area 111.

Furthermore, the method 200 comprises capturing 204 displacement information which is directed at dislocating the displayed information 121 on the viewing zone 110. The displacement information may be captured using a tactile input device 130 (e.g. a touch pad). The tactile input device 130 may be located at a steering device 131 (e.g. a steering wheel) of a vehicle.

In addition, the method 200 comprises determining 205 an actual point of gaze based on the measured point of gaze and based on the captured displacement information. The first offset from the offset file may also be taken into account for determining the actual point of gaze. In particular, the measured point of gaze may be offset using the captured displacement information and possibly the first offset, in order to determine the actual point of gaze.

Furthermore, the method 200 comprises selecting 206 a first area 111 from the plurality of selectable areas 111 which corresponds to the actual point of gaze. Typically, the actual point of gaze falls within the first area 111. In other words, the first area 111 may be selected as the area 111 from the plurality of areas 111 that the determined actual point of gaze falls into. The plurality of selectable areas 111 may be associated with a plurality of functions, respectively, and the method 200 may further comprise initiating a first function from the plurality of functions which corresponds to the first area 111.

As such, the method 200 provides reliable and adaptive means for performing input using eye tracking, and/or for implicitly calibration an eye tracking based user interface system 100. In particular, the capturing of displacement information with regards to displayed information 121 that represents the estimated point of gaze enables a user to intuitively calibrate an eye tracking based user interface system 100.

The method 200 may further comprise steps for determining and storing calibration information based on the captured displacement information. In particular, the method may comprise determining a second area 111 from the plurality of selectable areas 111 which corresponds to the measured point of gaze. A (possibly) updated offset for offsetting the measured point of gaze may be determined based on the captured displacement information. Furthermore, the updated offset may be determined based on one or more offsets already stored within the offset file (e.g. based on an offset which is already stored within the offset file in association with the second area 111). In particular, determining the updated offset may comprise determining a stored offset which is already stored within the offset file in association with the second area 111 and determining the updated offset based on the stored offset and based on the captured displacement information. By way of example, a (possibly weighted) mean value may be determined based on the one or more stored offsets and based on the captured displacement information. The updated offset may then be stored in association with the second area 111 within the offset file. By doing this, the calibration of the eye tracking based user interface system 100 may be automatically improved and adapted.

The method may further comprise determining at least two offsets which are stored within the offset file in association with at least two corresponding selectable areas 111. A third offset for a third selectable area 111 may be determined by interpolating the at least two offsets. The third offset may then be stored in association with the third area 111 within the offset file. By doing this, the complete viewing zone 110, i.e. all of the plurality of areas 111, may be calibrated using only a limited number of previously determined offsets. As such, calibration may be simplified.

In the present document, an eye tracking based user interface system 100 has been described which allows for a precise and reliable user input using eye tracking. The user interface may be provided without using an explicit calibration routine. By capturing the displacement information using input means which are different from the eye tracking based input means, the calibration of the eye tracking based user interface may be provided in an implicit manner, possibly without a user of the system realizing the occurrence of such calibration.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A method for selecting a first area from a viewing zone which comprises a plurality of selectable areas, the method comprising the acts of:
measuring a point of gaze of a user on the viewing zone, thereby providing a measured point of gaze;
determining an estimated point of gaze based on the measured point of gaze;
displaying information regarding the estimated point of gaze on the viewing zone;
capturing displacement information which is directed at dislocating the displayed information on the viewing zone;
determining an actual point of gaze based on the measured point of gaze and based on the captured displacement information; and
selecting a first area from the plurality of selectable areas which corresponds to the actual point of gaze.

2. The method of claim 1, wherein the displacement information is captured using a tactile input device.

3. The method of claim 1, wherein determining the estimated point of gaze comprises:
determining a first offset for the measured point of gaze from an offset file; and
determining the estimated point of gaze by offsetting the measured point of gaze using the first offset.

4. The method of claim 3, further comprising:
determining a second area from the plurality of selectable areas which corresponds to the measured point of gaze;
determining an updated offset for offsetting the measured point of gaze based on the captured displacement information; and
storing the updated offset in association with the second area within the offset file.

5. The method of claim 4, wherein the updated offset is determined also based on one or more offsets already stored within the offset file.

6. The method of claim 5, wherein determining the updated offset comprises:
determining a stored offset which is already stored within the offset file in association with the second area; and
determining the updated offset based on the stored offset and based on the captured displacement information.

7. The method of claim 3, further comprising:
determining at least two offsets which are stored within the offset file in association with at least two corresponding selectable areas;
determining a third offset for a third selectable area by interpolating the at least two offsets; and
storing the third offset in association with the third area within the offset file.

8. The method of claim 1, wherein the measured point of gaze is determined using image data captured by an image sensor.

9. The method of claim 1, wherein the areas from the plurality of selectable areas are adjacent with respect to one another.

10. The method of claim 1, wherein the information regarding the estimated point of gaze on the viewing zone comprises:
a visible icon which is displayed on the viewing zone; and/or
a highlight of a selectable area from the plurality of selectable areas that the estimated point of gaze corresponds to.

11. The method of claim 1, wherein:
the plurality of selectable areas is associated with a plurality of functions, respectively; and
the method further comprises, initiating a first function from the plurality of functions which corresponds to the first area.

12. The method of claim 1, wherein the actual point of gaze falls within the first area.

13. The method of claim 2, wherein:
the viewing zone is located on a dashboard of a vehicle; and
the tactile input device is located at a steering device of the vehicle.

14. A control unit for an eye tracking based user interface system, wherein the control unit is configured to:
determine a measured point of gaze of a user on a viewing zone of the eye tracking based user interface system, wherein the viewing zone comprises a plurality of selectable areas;
determine an estimated point of gaze based on the measured point of gaze;
cause the output of information regarding the estimated point of gaze on the viewing zone;
determine displacement information which is directed at dislocating the displayed information on the viewing zone;
determine an actual point of gaze based on the measured point of gaze and based on the captured displacement information; and
select a first area from the plurality of selectable areas which corresponds to the actual point of gaze.

15. An eye tracking based user interface system, comprising:
an image sensor configured to capture image data regarding a point of gaze of a user of the eye tracking based user interface system;
a viewing zone configured to provide a plurality of selectable areas with selectable areas that are visibly distinct, and configured to provide visible information regarding an estimated point of gaze of the user on the viewing zone;
a tactile input device configured to capture displacement information which is input by the user for dislocating the information regarding the estimated point of gaze; and
a control unit configured to:
determine a measured point of gaze of a user on a viewing zone of the eye tracking based user interface system, wherein the viewing zone comprises a plurality of selectable areas;
determine an estimated point of gaze based on the measured point of gaze;
cause the output of information regarding the estimated point of gaze on the viewing zone;
determine displacement information which is directed at dislocating the displayed information on the viewing zone;
determine an actual point of gaze based on the measured point of gaze and based on the captured displacement information; and
select a first area from the plurality of selectable areas which corresponds to the actual point of gaze.
